(19) United States
(12) Patent Application Publication
(10) Pub. No.: US 2002/0134758 A1
(43) Pub. Date: Sep. 26, 2002

(54) Arc splitter plate

(75) Inventors: Anil Raj Duggal, Niskayuna, NY (US); Hemant Kumar Mody, Plainville, CT (US); Joseph Benjamin Kelaita, Bristol, CT (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(73) Assignee: General Electric Company

(21) Appl. No.: 09/777,641

(22) Filed: Feb. 6, 2001

(51) Int. Cl. H01H 9/30; H01H 33/02

(52) U.S. Cl. 218/154

(57) ABSTRACT

An arc splitter comprises an electrically conductive polymer composition. In exemplary embodiments, the polymer may be an intrinsically electrically conductive polymer system such as polyaniline, or part of a composite material formed of the polymer and electrically conductive filler.

### BACKGROUND OF THE INVENTION

This invention relates to current interruption devices. In particular, this invention relates to arc splitter plate materials and designs for such devices.

Current interruption devices, such as over-current protection circuit breakers, rely on the separation of two electrical contacts to break a current. As these two electrical contacts separate, an electrical arc strikes between them. Current still flows until this arc is extinguished even though the two contacts are mechanically separated.

Circuit breakers are designed to reduce the amount of time required for this arc to extinguish. Generally, this involves creating a condition such that the voltage required to sustain the arc increases quickly to a point where its value is above that which can be provided by the circuit. When this occurs, the arc extinguishes.

A description of traditional circuit breaker designs utilized to attain this goal can be found in the book Circuit Interruption Theory and Techniques edited by Thomas E. Browne (Marcel Dekker, Inc., 1984). One common design is a switch mechanism such that, when a high current condition occurs and the two contacts separate, the gap distance between them increases as quickly as possible. This exploits the fact that the voltage required to sustain an arc increases with the gap distance.

Another design often used in concert with this switch mechanism is an arc chute, which provides a path for the arc to jump from the region between the two opening contacts to a set of metal arc splitter plates. The function of the arc splitter plates is to split the arc into a series of smaller arcs. Arc splitter plates take advantage of the fact that there is minimum voltage, typically about 30 to 80 volts, necessary to sustain any single arc, the minimum voltage being determined by the sum of the cathode drop and anode fall within that arc. Thus, splitting an arc into a series of arcs can rapidly increase the voltage required to sustain the whole series. Additionally, the arc splitter plates cool the arcs, which further increases the voltage required to sustain them.

The operation of prior art arc splitter plates is shown in FIGS. 1 and 2. In FIG. 1, a contact arm 14 of circuit breaker 13 is rotating counter-clockwise, causing a movable contact 15 to separate from fixed contact 17. An arc 18 forms between movable and fixed contacts 15, 17 as they separate. Adjacent to movable and fixed contacts 15, 17, are a series of arc splitter plates 21. Arc splitter plates 21 are supported by electrically insulating side plates or one or more electrically insulating posts (see, for example, FIGS. 3-5). As the contacts continue to separate, the arc 18 moves to the arc splitter plates 21 as shown in FIG. 2.

FIG. 3 shows another example of a prior art circuit breaker 13 having arc splitter plates 21. Here, a series of metal arc splitter plates 21 are positioned between two electrically insulating side supports 19 as shown in FIGS. 4 and 5. Side supports 19 are typically formed from a ceramic or other material that can withstand high temperatures. Arc splitter plates 21 commonly include tabs 27 that fit in to slots 29 formed in side supports 19 to hold arc splitter plates 21 in the desired position.

Although arc splitter plates significantly reduce the time before an arc is extinguished, it would be desirable to further reduce the time between a trip event and complete cessation of current. Furthermore, it would be desirable to do so while reducing the number of manufacturing steps required to assemble an arc plate assembly, or arc chute.

### BRIEF SUMMARY OF THE INVENTION

The above discussed and other drawbacks and deficiencies of the prior art are overcome or alleviated by an arc splitter plate wherein at least one electrode of the arc comprises an electrically conductive polymer composition.

The above discussed and other features and advantages of the present invention will be appreciated and understood by those skilled in the art from the following detailed description and drawings.

### BRIEF DESCRIPTION OF THE DRAWINGS

Referring now to the exemplary drawings wherein like elements are numbered alike in the several Figures:

FIGS. 1 and 2 are partial schematic views of a prior art circuit breaker showing the progression of electrical arcs through a series of arc splitter plates as the circuit is opened;

FIG. 3 is an exemplary circuit breaker according to the prior art;

FIGS. 4 and 5 show perspective and exploded views, respectively, of a prior art arc splitter plate assembly for the circuit breaker shown in FIG. 3;

FIG. 6 is a schematic cross-section view of an arc splitter plate assembly;

FIG. 7 is a schematic cross-section view of another arc splitter plate assembly;

FIG. 8 is a schematic cross-section view of another arc splitter plate assembly;

FIG. 9 is a schematic cross-section view of yet another arc splitter plate assembly; and

FIG. 10 shows a graph representing current and voltage verses time for various types of electrical contacts.

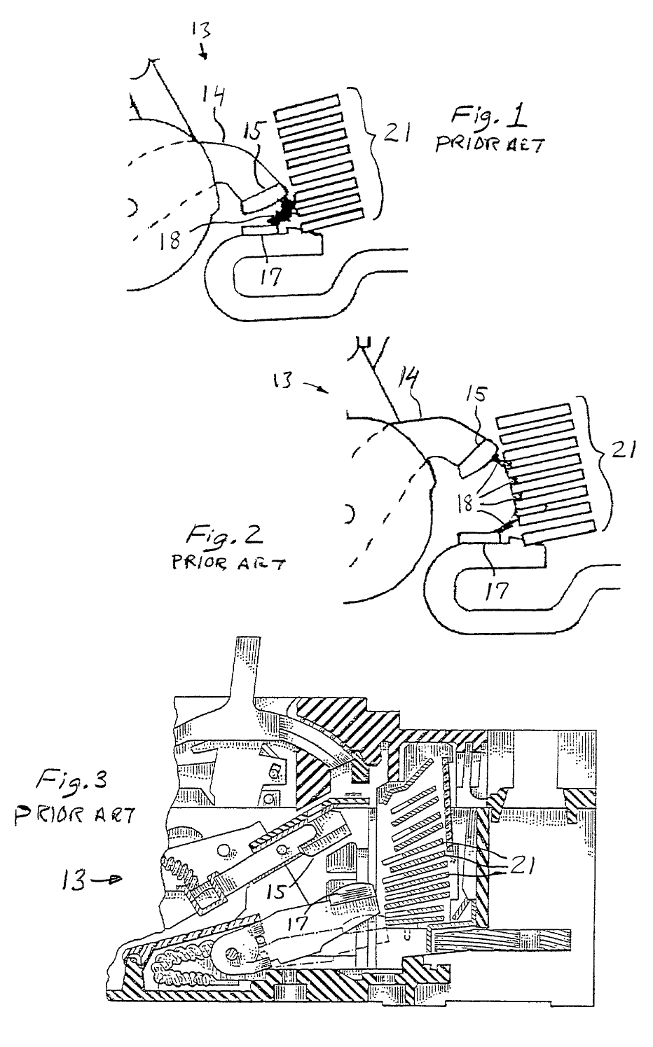

### DETAILED DESCRIPTION OF THE INVENTION

The inventors hereof have discovered that when electrically conductive polymer compositions are utilized as one or both electrodes of an arc, the resulting arc voltage is significantly larger than that which occurs when traditional metal electrodes are utilized.

Such polymer compositions may include a nonconductive polymer system together with electrically conductive filler. By way of example, contemplated polymers in the nonconductive polymer system include thermoplastics, including polytetrafluoroethylene, polyethyleneglycol, polyethylene, polycarbonate, polyimide, polyamide, polymethylmethacrylate, and polyester polymers; thermosets, including epoxy, polyester, polyurethane, phenolic, and alkyd polymers; and elastomers, including polyorganosiloxane (silicone), polyurethane, isoprene rubber, and neoprene, as well as mixtures or blends including any one of the above polymers.

These nonconductive polymer systems may be rendered electrically conductive by the addition of one or more electrically conductive fillers. The identity and quantity of the filler or fillers is readily determined by one of ordinary skill in the art, depending upon factors such as the target conductivity, the conductivity of the filler, the presence of other components, and the physical properties of the final composition. Electrically conductive fillers are known in the art, and may be particulate or fibrous. Exemplary electrically conductive fillers include but are not limited to particulate or fibrous intrinsically electrically conductive polymers such as polyacetylenes, polyanilines, polythiophenes, and the like, carbon, nickel, silver, gold, aluminum, copper, and iron, as well as stainless steel and other metal alloys including any one of the above metals, and combinations comprising one of the foregoing materials or metal alloys. Carbon may be in the form of meso face and isotropic pitch fibers, carbonized polyacrylonitrile (PAN) fibers, graphite plates, particles, or whiskers, carbon black, vapor grown carbon fibers having diameters in the range from about 3 nanometers to about 500 nanometers, graphitized vapor grown carbon fibers, nanotubes, and the like.

The electrically conductive polymer composition preferably has a resistivity of between about 10⁻² and about 10⁶ milliohm-cm and more preferably has a resistivity of between about 10⁻² and about 10³ milliohm-cm. To achieve these values, the electrically conductive filler preferably has an average particle size of between about 10⁻² and about 10² microns and typically is present in the composition at a concentration in the range from about 3% to about 50% by volume. One embodiment of the electrically conductive polymer composition comprises a epoxy and from about 50% to about 80%, preferably about 60 to about 70% by weight nickel, wherein the nickel has an average diameter of greater than 1 micron.

In addition to the above-listed non-conductive polymer systems, it is also possible to use intrinsically electrically conductive polymer systems such as polyacetylenes, polyanilines, polythiophenes, and the like. The intrinsically conductive polymer systems may be used with or without electrically conductive fillers, the type and amount again depending upon factors such as the target conductivity, the conductivity of the filler, the presence of other components, and the physical properties of the final composition.

Other fillers and additives may used to improve or modify other properties of the electrically conductive polymer composition, such as the mechanical properties; dielectric properties; or flame-resistance. Exemplary fillers include reinforcing fillers such as fumed silica, or extending fillers such as precipitated silica and mixtures thereof. Other exemplary fillers include titanium dioxide, lithopone, zinc oxide, diatomaceous silicate, silica aerogel, iron oxide, diatomaceous earth, calcium carbonate, silazane treated silicas, silicone treated silicas, glass fibers, magnesium oxide, chromic oxide, zirconium oxide, alpha-quartz, calcined clay, carbon, graphite, cork, cotton sodium bicarbonate, boric acid, alumina-hydrate, and the like. Other additives may include, for example, impact modifiers for increasing the impact resistance of the plates; flame retardants for preventing flame formation and/or inhibiting flame formation in the current limiter; dyes and colorants for providing specific color components in response to customer requirements; UV screens for preventing reduction in component physical properties due to exposure to sunlight or other forms of UV radiation.

The polymer systems used in the manufacture of the arc splitter plates may be selected for enhanced arc quenching properties. For example, use of melamine resins comprising a combination of melamine (C₃H₆N₆) and formaldehyde (HCHO) release gaseous hydrogen compounds at elevated temperatures, which can cool, deionize, and quench the arc. Melamine resins or similar compounds may also be used as an additional filler in combination with the polymer composition described above to enhance the arc-quenching nature of the arc splitter plates.

Use of an electrically conductive polymer composition as a novel material in an arc splitter plate reduces assembly costs are ordinarily associated with arc chutes, and makes readily available a number of alternative arc splitter plate assembly constructions, such as those shown in cross-section at 50 in FIGS. 6 to 9. It is to be understood that FIGS. 6 to 9 are not intended to be drawn to scale, and that it is within the scope of the present invention to vary the total number of plates from that which is shown in the Figures.

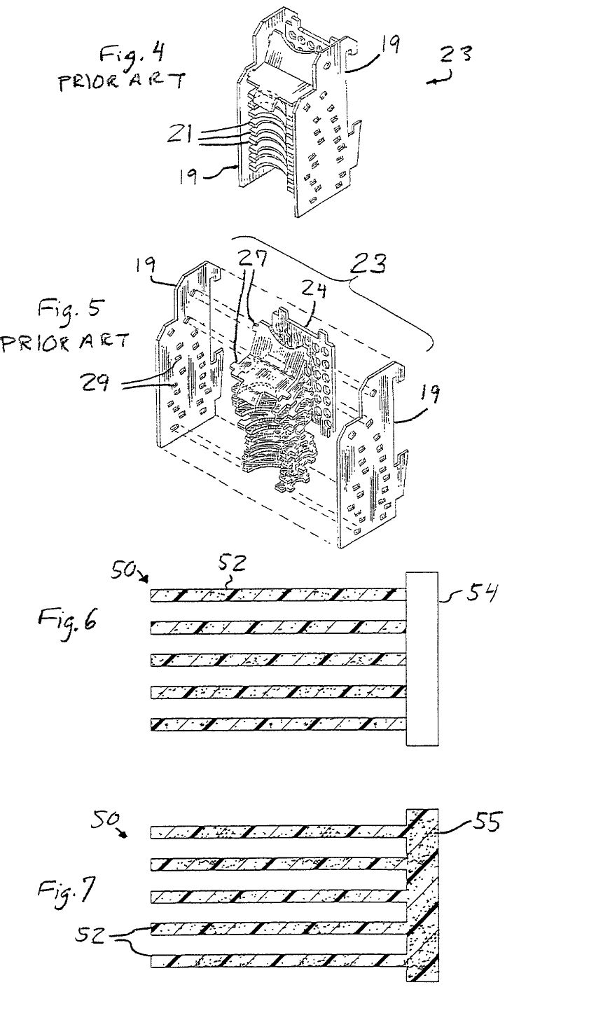

FIG. 6 shows a schematic representation of an arc splitter plate assembly 50 comprising a series of arc splitter plates 52 supported by an insulating support 54. Support 54 may be a post or side supports, such as those shown at 19 in FIGS. 4 and 5. Although all the arc splitter plates shown in FIG. 6 are formed of the electrically conductive polymer composition, it is also contemplated that the arc splitter plate or plates closest to the stationary contact in a current interruption device may instead be made of metal, to help ensure that the arc shifts to arc splitter plate assembly 50. Furthermore, the conductivity of each plate may vary from one plate to the next. For example, the plates closer to the stationary contact may advantageously be more conductive than plates farther from the stationary contact. Arc splitter plate assembly 50 may be produced by injection molding, or other known molding techniques. Such known plastics manufacturing techniques will significantly reduce the number of manufacturing steps required to produce an arc chute.

FIG. 7 shows another embodiment in which the entire arc splitter plate assembly 50, including support 55, is made up of the electrically conductive polymer composition. In this case it would be advantageous to use a thermoplastic material such as polyethylene, containing nickel filler, as the thermoplastic allows easy fabrication through injection molding and the nickel provides advantageous magnetic properties for maintaining the arcs within the arc splitter plates 52. Of course, other manufacturing techniques are contemplated. For instance, a continuous extrusion process, with contiguous supports 55 extruded along with arc splitter plates 52, but formed from a non-electrically conductive material may be used to produce arc splitter plate assembly 50.

FIG. 8 shows an example in which the arc splitter plates are formed of a metal core 58 that is coated with conductive polymer composition 56. For example, metal core 58 may be formed of steel. The electrically conductive composition may be disposed partially or completely over the metal core. As will be readily appreciated by one of ordinary skill in the art, the method of applying the conductive polymer composition is dependent upon the composition and physical properties such as the flow properties of the conductive polymer composition.

FIG. 9 shows another embodiment in which the metal and polymer composition arc splitter plates 60, 52 are interleaved.

Other configurations may occur to a person of ordinary skill in the art. The invention is further illustrated by the following non-limiting Examples.

### EXAMPLE 1

In this example, the electrically conductive polymer composition comprises an epoxy resin containing approximately 20% by volume of nickel in the form of particles about 2.5 microns in diameter. The epoxy resin is formed by blending a bisphenol A epoxy (EPON 828 from Shell Chemical Company) with about 3% by weight of a boron trifluoride monoethylamine complex (as a curing agent), followed by blending with about 10% by weight of a polyglycol low viscosity flexibilizer (DER 732 from Dow Chemical). This epoxy blend was then mixed with the nickel (Ni-255 A/C Fine from Novamet Specialty Products Corporation) for 1 hour at 110° C. The mixture was placed into a 3-inch by 3-inch by ⅛-inch steel mold and cured in an autoclave at a pressure of 40 pounds per square inch (PSI) for 1 hour at 120° C., followed by 2 hours at 170° C. This material has a measured resistivity of approximately 20 milliohm-cm.

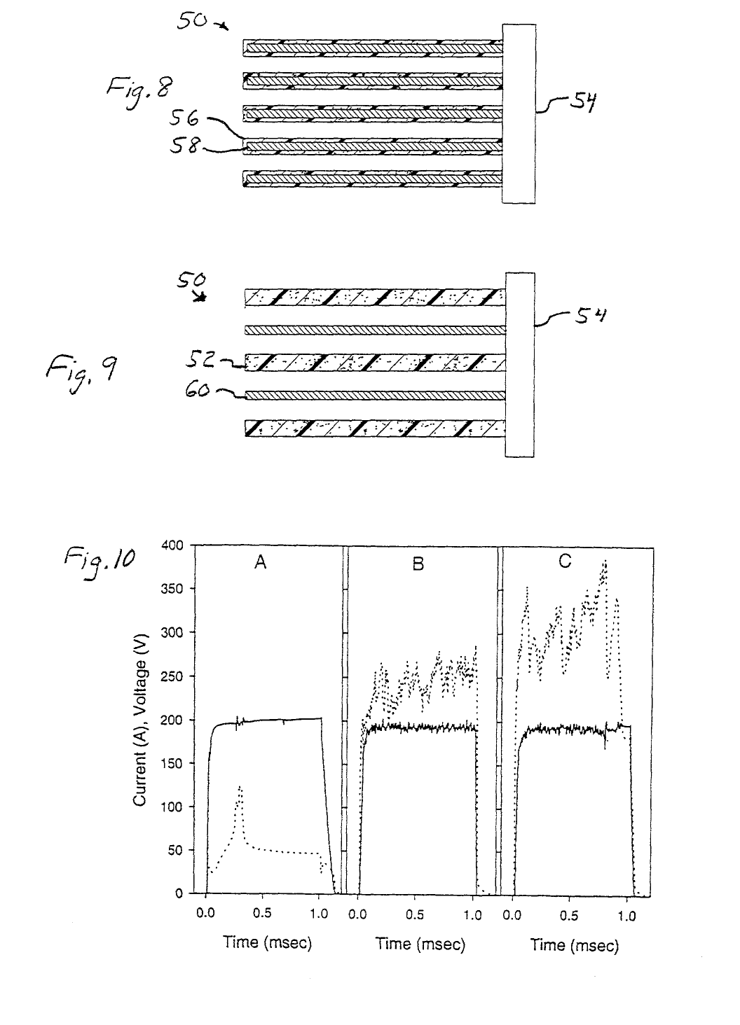

Referring now to FIG. 10, the graph shows the current (solid curves) and voltage (dotted curves) between two electrodes when an arc is present between them. In part A of FIG. 10, two steel electrodes are used. In part B, one electrode is steel and the other is the above-described nickel-epoxy composite material, and in part C, both electrodes consist of the nickel-epoxy composite material. In all cases, the electrodes are separated by approximately 6 millimeters and a 200 ampere current pulse is provided with an amplifier system. The arcs were initiated with a fuse wire as is commonly known.

As may seen, the arc voltage increases by a factor of about 5 times, from about 50 volts to about 250 volts when one of the steel electrodes is replaced by the composite material, and by a factor of about 6 times when both steel electrodes are replaced by composite material. As shown more fully in Example 2 below, it has been found that the increase in voltage that is obtained depends on the properties of the composite such as the resistivity, the filler particle size, and the polymer type. The voltage increase appears to occur with a wide variety of polymers and a wide variety of conductive fillers.

### EXAMPLE 2

Specific examples that were tested and that show the increased arc voltage are shown the table below, wherein Polyethylene IP-40 is obtained from Dow Chemical Co.; Silver 262 is obtained from Nanopowders Industries; Silver 224 is obtained from Nanopowders Industries; Silver K0001 is obtained from Chemet Corporation, and Ni-255 A/C Fine is obtained from Novamet Specialty Products Corporation. The silver-filled curable silicone material (elastomer) was made by mixing two parts, A & B. The A part comprised a vinyl silicone organopolysiloxane fluid having terminal dimethylvinylsiloxy units and dimethylsiloxy units with a viscosity of 400 cps at 25.degree. C. (23 g), the Silver K0001, and a silicone hydride siloxane fluid having terminal trimethyl siloxy units to provide a fluid with about 0.8% by weight chemically combined hydrogen attached to silicon (1 g). The B part comprised the vinyl silicone organopolysiloxane fluid having terminal dimethylvinylsiloxy units and dimethylsiloxy units with a viscosity of 400 cps (2 g), dimethyl maleate (14 .mu.L) and Karstedt's platinum catalyst (83 .mu.L of a 5% platinum solution in xylene) [for details see U.S. Pat. No. 3,775,452, B. D. Karstedt (1973)]. The A component (40 g) and B component (0.44 g) were mixed and then poured into a mold and then cured in a Carver press at 150.degree. C., 30 minutes at 5000 pounds pressure.

| | | | Filler | Resistivity | Arc |
|---|---|---|---|---|---|
| Polymer Matrix | Conductive | Filler Particle | Amount | (milliohm- | Voltage |
| Material | Filler | Size (micron) | (vol %) | cm) | (V) |
| Polyethylene IP-40 | Silver 262 | 0.05-0.06 | 21 | 1.7 | 120-150 |
| Polyethylene IP-40 | Silver 224 | 0.05-0.06 | 21 | 0.25 | 96-120 |
| Polyethylene IP-40 | Silver K0001 | 2.4 | 21 | 2.5 | 150-170 |
| Silicone | Silver K0001 | 2.4 | 27 | 17 | >370 |
| Polyethylene IP-40 | Ni-255 A/C | 2.5 | 20 | 60 | 250-350 |
| | Fine | | | | |
| Polyethylene IP-40 | Ni-255 A/C | 2.5 | 17 | 150 | >370 |
| | Fine | | | | |
| Polyethylene(*) | Carbon Black | 0.05 | 38 | 170 | >370 |

*Taken from PL63 Prolim current limiter sold by ABB Control, Inc.

The increase in arc voltage has therefore been demonstrated in all main classes of polymers: thermoplastic (polyethylene), thermoset (epoxy), and elastomer (silicone) and with different conductive fillers (nickel, silver, and carbon). Although the arcing temperature may rise above the melting point of some of the thermoplastics and elastomers considered, it is believed that the highly localized and transient nature of the arcing within a circuit breaker will mitigate damage caused by the arcing.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. An article of manufacture comprising:
arc splitter plate comprising an electrically conductive polymer composition.

2. The article of claim 1 further comprising a metal core, said electrically conductive polymer composition being disposed over at least a portion of said metal core.

3. The article of claim 1 wherein said electrically conductive polymer composition comprises an intrinsically electrically conducive polymer system, an intrinsically electrically conductive polymer system and an electrically conductive filler, or a nonconductive polymer system and an electrically conductive filler.

4. The article of claim 3, wherein the intrinsically conductive polymer system is polyacetylene, polyanilines, polythiophene, or a mixture comprising at least one of the foregoing polymers.

5. The article of claim 3 wherein said nonconductive polymer system comprises a thermoplastic polymer, a thermoset polymer, or an elastomer.

6. The article of claim 5 wherein said thermoplastic polymer is polytetrafluoroethylene, polyethyleneglycol, polyethylene, polycarbonate, polyimide, polyamide, polymethylmethacrylate, polyester, or a mixture comprising at least one of the foregoing polymers.

7. The article of claim 5 wherein said thermoset polymer is epoxy, polyester, polyurethane, phenolic, alkyd, or a mixture comprising at least one of the foregoing polymers.

8. The article of claim 5 wherein said elastomer is silicone polyorganosiloxane, polyurethane, isoprene rubber, neoprene, or a mixture comprising at least one of the foregoing polymers.

9. The article of claim 3 wherein said nonconductive polymer system comprises an epoxy, a silicone, or a polyethylene.

10. The article of claim 3 wherein said intrinsically conductive or nonconductive polymer system comprises a resin that generates a deionizing gas when the resin is heated.

11. The article of claim 3 wherein said electrically conductive filler comprises electrically conductive carbon, nickel, silver, gold, aluminum, copper, iron, stainless steel, other metal alloys including any one of the above metals, or a combination comprising at least one of the foregoing fillers.

12. The article of claim 11 wherein said electrically conductive filler comprises particles have an average diameter of between about 10⁻² and about 10² microns.

13. The article of claim 3 wherein said electrically conductive polymer composition comprises between 3 and 50% by volume of said electrically conductive filler.

14. The article of claim 1 wherein said electrically conductive polymer composition has a resistivity of between 10⁻² and 10⁶ milliohm-cm.

15. The article claim 14 wherein said resistivity is between 10⁻² and 10².

16. The article of claim 1 wherein said electrically conductive polymer composition comprises an epoxy and from about 50% to about 80% by weight nickel, wherein the nickel has an average diameter of about 2.5 micron.

17. The article of manufacture of claim 16 wherein said composition comprises about 60% to about 70% by weight nickel.

18. A circuit breaker comprising:
a fixed contact;
a movable contact; and
an arc splitter plate assembly comprising a plurality of arc splitter plates adjacent to said fixed contact and said moving contact for rapidly extinguishing arcs formed therebetween, said plurality of arc splitter plates comprising an electrically conductive polymer composition.

19. The circuit breaker of claim 18 wherein said electrically conductive polymer composition comprises an intrinsically electrically conducive polymer system, an intrinsically electrically conductive polymer system and an electrically conductive filler, or a nonconductive polymer system and an electrically conductive filler.

20. The circuit breaker of claim 19, wherein the intrinsically conductive polymer system is polyacetylene, polyaniline, polythiophene, or a mixture comprising at least one of the foregoing polymer systems.

21. The circuit breaker of claim 19 wherein said nonconductive polymer system comprises a thermoplastic polymer, a thermoset polymer, or an elastomer.

22. The circuit breaker of claim 21 wherein said thermoplastic polymer is polytetrafluoroethylene, polyethyleneglycol, polyethylene, polycarbonate, polyimide, polyamide, polymethylmethacrylate, polyester, or a mixture comprising at least one of the foregoing polymers.

23. The circuit breaker of claim 21 wherein said thermoset polymer is epoxy, polyester, polyurethane, phenolic, alkyd, or a mixture comprising at least one of the foregoing polymers.

24. The circuit breaker of claim 21 wherein said elastomer is silicone polyorganosiloxane, polyurethane, isoprene rubber, neoprene, or a mixture comprising at least one of the foregoing polymers.

25. The circuit breaker of claim 19 wherein said nonconductive polymer comprises an epoxy, a silicone, or a polyethylene.

26. The circuit breaker of claim 19 wherein said intrinsically conductive or nonconductive polymer system comprises a resin that generates a deionizing gas when the resin is heated.

27. The circuit breaker of claim 19 wherein said electrically conductive filler comprises electrically conductive carbon, nickel, silver, gold, aluminum, copper, iron, stainless steel, other metal alloys including any one of the above metals, or a combination comprising at least one of the foregoing fillers.

28. The circuit breaker of claim 27 wherein said electrically conductive filler comprises particles have an average diameter of between about 10⁻² and about 10² microns.

29. The circuit breaker of claim 19 wherein said electrically conductive polymer composition comprises between 3 and 50% by volume of said electrically conductive filler.

30. The circuit breaker of claim 18 wherein said electrically conductive polymer composition has a resistivity of between 10⁻² and 10⁶ milliohm-cm.

31. The circuit breaker claim 30 wherein said resistivity is between 10⁻² and 10².

32. The circuit breaker of claim 18 wherein said electrically conductive polymer composition comprises an epoxy and from about 50% to about 80% by weight nickel, wherein the nickel has an average diameter of about 2.5 micron.

33. The circuit breaker of manufacture of claim 32 wherein said composition comprises about 60% to about 70% by weight nickel.

34. The circuit breaker of claim 19 wherein said arc splitter plate assembly is formed entirely of said composite material.

35. The circuit breaker of claim 18, said arc splitter plate assembly further comprising a plurality of metal arc splitter plates interleaved with said plurality of arc splitter plates comprising said electrically conductive polymer composition.
